(19) United States
(12) Patent Application Publication
(10) Pub. No.: US 2012/0169463 A1
(43) Pub. Date: Jul. 5, 2012

(54) APPARATUS AND METHOD FOR AUTHENTICATING BIOMETRIC INFORMATION

(75) Inventors: Yo-Shik Shin, Seoul (KR); Geum-Yong Kim, Seoul (KR); Eun-Ji Shin, Guri (KR)

(73) Assignee: UNION COMMUNITY CO., LTD., Seoul (KR)

(21) Appl. No.: 13/335,186

(22) Filed: Dec. 22, 2011

(30) Foreign Application Priority Data
Dec. 29, 2010 (KR) 10-2010-0137482

(51) Int. Cl. G06F 7/04

(52) U.S. Cl. 340/5.82

(57) ABSTRACT

A method for biometric authentication and a system using the same are provided. The biometric authentication system of the present invention separates pre-registered biometric information of a user into a plurality of separated biometric information, disperses them to a plurality of databases and manages them. Accordingly, when a user authentication process is needed, the biometric authentication system performs an authentication by obtaining the separated biometric information that are managed by a plurality of databases and composing registered biometric information. The present invention reduces the risk of leakage of biometric information of a user due to hacking or theft since it allows biometric information to be separated, disperse and managed, which conventionally is store as a single file on a server, a database or a security token.

### CROSS-REFERENCE TO RELATED APPLICATIONS

This application claims priority under 35 U.S.C §119 from Korean Patent Application No. 10-2010-0137482, filed on Dec. 29, 2010, the disclosure of which is incorporated herein by reference in its entirety.

### BACKGROUND OF THE INVENTION

1. Technical Field

Apparatuses and methods consistent with the present exemplary embodiments relate to securing biometric information of a registered user in a server or a database and to performing a biometric authentication.

2. Description of the Related Art

As trading of goods and services via online such as the Internet becomes common, when a user try to obtain a service or information, a service provider generally performs a user authentication to identify a user as a true pre-registered user and thus, the service or information is provided to the true pre-registered user.

Recently, biometric authentication using finger prints, face, eye iris, vein, voice, etc of a user is widely utilized as means for authentication of a user since its uniqueness, its difficulty to copy and its possibility of loss-free.

In case of using biometric authentication, if a user try to get an authentication through a method of having his/her finger print, face, iris, vein touched an authentication apparatuses identifies whether or not the user who are trying the authentication is a registered user by comparing the obtained biometric information to biometric information that is pre-registered and stored on a server or others.

However, if biometric information stored on a server of authentication apparatuses is leaked out, the damage is more severe than when other means for authentication is leaked, since biometric information is not able to be altered. In this point, biometric authentication is not perfect in terms of security.

In order to address this problem, users store their own physical information on a storage unit such as a card and a bio security token and posses it on their own. However, there is still a possibility of leakage of information by loss of the storage unit.

### SUMMARY

Exemplary embodiments of the present invention address at least the above problems and/or disadvantages and other disadvantages not described above. Also, the present invention is not required to overcome the disadvantages described above, and an exemplary embodiment of the present invention may not overcome any of the problems described above.

The present invention is to provide a system and method for securing biometric information of a user in a server or a database and for performing an authentication.

Also, this invention is to provide a system and method for strengthening security of biometric information registered with a server or others by separating registered biometric information into a plurality number of separated biometric information, dispersing and managing them.

According to an aspect of an exemplary embodiment, there is provided a system for biometric authentication, the system comprises: a plurality of databases that separately stores each of a plurality of separated biometric information generated by separating registered biometric information of a user and separately manage each of them; a removable storage unit that stores a plurality of identifiers corresponding to each of the plurality of the separated biometric information; and a biometric authentication apparatus that authenticates the user by receiving an input of biometric information for authentication from the user and comparing it to the registered biometric information.

Herein, the biometric authentication apparatus comprises: a biometric information composing unit that makes a request for the separated biometric information to the plurality of databases using the plurality of identifiers that are read from the removable storage unit and composes the registered biometric information of a plurality of the separated biometric information provided by the plurality of databases according to the request; and an authenticating unit that proceeds with the authentication by comparing the composed registered biometric information to the biometric information for authentication.

According to an exemplary embodiment, the registered biometric information may be separated into more number of biometric information than that of the identifier, separated biometric information which is not mapped onto by the identifier may be stored on the removable storage unit. In this case, the biometric authentication apparatus may compose the registered biometric information using the separated biometric information stored on the removable storage unit and the plurality of separated biometric information provided from the plurality of databases at the authentication stage.

According to another exemplary embodiment, the biometric authentication apparatus and the removable storage unit may be embodied in one body and constitute a portable biometric authentication apparatus. A portable biometric authentication apparatus may be a bio security token.

According to another exemplary embodiment, all the separated biometric information that are stored separately on the databases may be stored on the biometric authentication apparatus and may be managed all together. In this case, the biometric authentication apparatus proceed with the authentication by searching separated biometric information corresponding to the plurality of identifiers that are read from the removable storage unit, out of the all separated biometric information stored on its own and extracting them and composing the registered biometric information using them.

According to another exemplary embodiment, a method for authenticating a user, comprising: storing separately each of a plurality of separated biometric information generated by separating registered biometric information of a user on a plurality of databases and separately managing each of them; and authenticating the user by receiving an input of biometric information for authentication from the user and comparing it to the registered biometric information, after a biometric authentication apparatus is connected to a removable storage unit that stores a plurality of identifiers corresponding to each of the plurality of separated biometric information.

The authenticating comprises: making a request for the separated biometric information to the plurality of databases using the plurality of identifiers that are read from the removable storage unit and being provided with them, and composing, by the biometric authentication apparatus, registered biometric information for authentication of (using) the provided plurality of separated biometric information.

### BRIEF DESCRIPTION OF THE DRAWINGS

The above and/or other aspects of the present invention will be more apparent by describing certain exemplary embodiments with reference to the accompanying drawings, in which:

FIG. 1 is a block diagram illustrating a system for biometric authentication according to an exemplary embodiment;

FIG. 2 is a flow chart provided to explain the operation of the biometric authentication system of the FIG. 1;

FIG. 3 is a block diagram illustrating a system for biometric authentication according to another exemplary embodiment; and

FIG. 4 is a block diagram illustrating a system for biometric authentication according to another exemplary embodiment.

### DETAILED DESCRIPTION OF EMBODIMENTS OF THE INVENTION

Certain exemplary embodiments will now be described in greater detail with reference to the accompanying drawings.

In the following description, the same drawing reference numerals are used for the same elements even in different drawings. The matters defined in the description, such as detailed construction and elements, are provided to assist in a comprehensive understanding. Also well-known functions or constructions are not described in detail since they would obscure explanation with unnecessary detail.

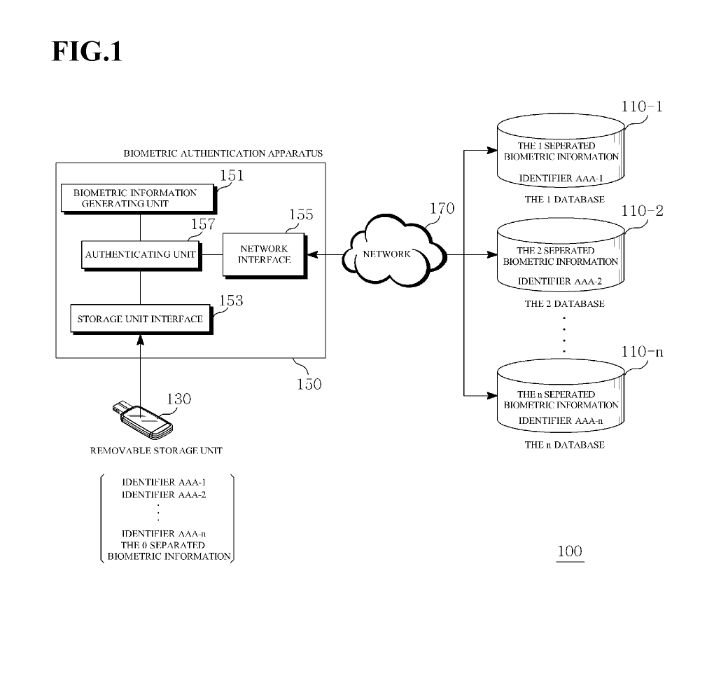

With reference to FIG. 1, a biometric authentication system 100 includes a plurality of databases 110-1, 110-2, 110-n, a removable storage unit 130 and a biometric authentication apparatus 150, and the biometric authentication 150 and the plurality of databases 110-1, 110-2, 110-n are connected through a network 170.

Each of separated biometric information is respectively stored on the plurality of databases 110-1, 110-2, 110-n. Herein, biometric information may be fingerprints, eye iris, face, etc that can be obtained from a user and can identify the user, and separated biometric information is biometric information generated by separating registered biometric information of the user. Also, the registered biometric information is a biometric information that is pre-input from a user and registered for authenticating the user.

FIG. 1 illustrates that registered biometric information is separated into n number of separated biometric information, and n number of databases 110-1, 110-2, 110-n store separately each of separated biometric information. However, this is only an exemplary embodiment and m(m<n) number of databases may apportion and register n number of separated biometric information.

Each of separated biometric information is identified by a specific identifier. For example, in a case where the identifier of registered biometric information is ‘AAA’, the identifier of the 1^{st} separated biometric information may be ‘AAA-1’ and the identifier of the n separated biometric information may be ‘AAA-n’. Each of databases (110-1, 110-2, 110-n) shares in common the identifiers of separated biometric information that they have and thus, may search and manage corresponding separated biometric information. Each of databases 110-1, 110-2, 110-n may possess separated biometric information of a plurality of users, which are identified and managed by identifiers.

The present invention improves a level of security by separating registered biometric information into a plurality of biometric information, registering them to different databases and storage units, and managing them.

A removable storage unit 130 is possessed and carried by users as it belongs to user's area, and may be a security token having Universal Serial Bus (USB), a contact/contactless type card, and may additionally store a authorized digital certificate of a user.

When a user authentication is performed, the removable storage unit 130 is contacted with a biometric authentication apparatus 150, and n number of identifiers AAA-1, AAA-2, . . . AAA-n corresponding to n number of separated biometric information of registered biometric information of a user are stored on the removable storage unit 130.

According to an exemplary embodiment, registered biometric information may be separated into more number of separated biometric information than the number of the identifiers (n). Accordingly, separated biometric information which any identifier is not mapped onto may be stored on the removable storage unit 130 and possessed by the user.

The biometric authentication apparatus 150 may be embodied in a various forms. The apparatus 150 is generally embodied as a computer, a note book, a mobile phone and a smart phone, and also as an In-and-out-management device and other devices for authentication use only.

The biometric authentication apparatus 150 comprises a biometric information generating unit 151 that generates biometric information for authentication from a user, a storage unit interface 153 that is connected to the removable storage unit (130) like a Universal Serial Bus (USB), a network interface 155 that is connected to databases 110-1, 110-2, 110-n via a network 170 and an authenticating unit 157 that authenticates whether a user is a registered user by comparing biometric information for authentication generated from the biometric information generating unit 151 to registered biometric information.

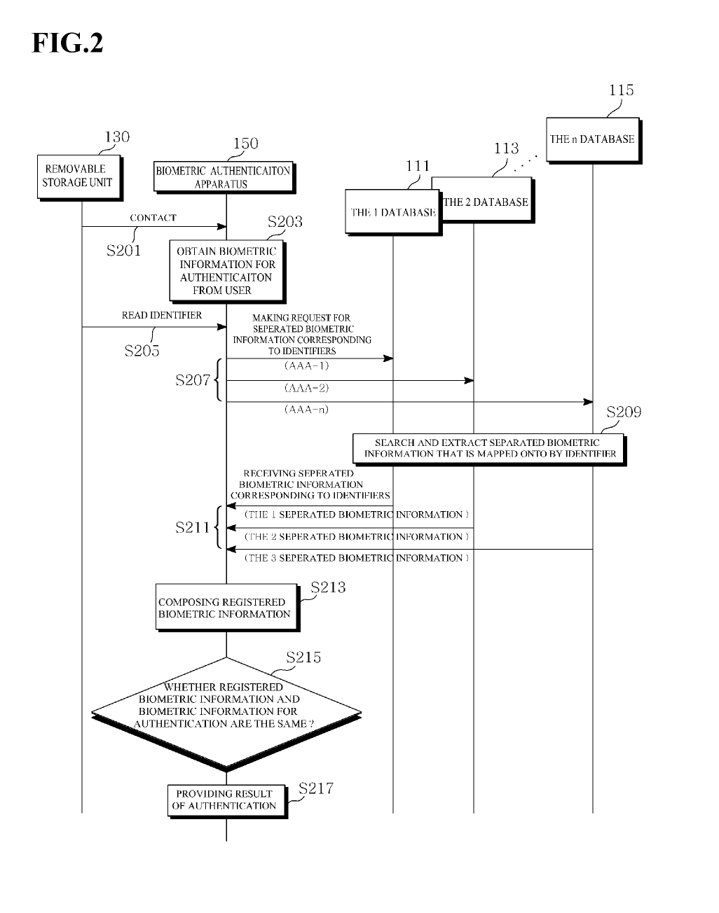

With reference to FIG. 2, the operation of the biometric information authentication system 100 is explained as below focusing on the operation of the authenticating unit 157.

A user have the removable storage unit 130 having his or her separated biometric information being accessed to the biometric authentication apparatus 150 in order to biometric authentication process (S201), and then the biometric information generating unit 151 of the biometric authentication apparatus 150 captures biometric information for authentication from the user's body and provide it to the authenticating unit (S203).

In a case where biometric information for authentication is captured from a user's body, the authenticating unit 157 read identifiers AAA-1˜AAA-n of separated biometric information from the removable storage unit 130 to compose registered biometric information (S205), and requests corresponding separated biometric information that are mapped onto by the identifiers by providing the identifiers to the plurality of databases 110-1, 110-2, 110-n (S207).

The plurality of databases (110-1, 110-2, 110-n) search and extract separated biometric information that are mapped onto by the identifiers provided by a user and provide them to the biometric authentication apparatus 150 (S209, S211).

The authenticating unit 157 composes registered biometric information using n number of separated biometric information provided from the databases 110-1, 110-2, 110-n and performs an authentication by comparing it to biometric information for authentication and confirming its identification. As explained above, separated biometric information may be composed in already known methods (S213, S215).

The authenticating unit 157 has an authentication process end by displaying the result of S215 to a user or proving it to other media (S217).

By these methods, registered biometric information of a user is separated, stored on a plurality of databases, and managed, and provided for authentication process after being composed by the information of identifiers provided by a user. Accordingly, although registered authentication information of a user stored on databases or others media is leaked out due to hacking or other unexpected accidents, the information can not function as biometric information, and it improves a level of security.

The S205 and S207 may be performed before the S203 or at the same time of S203, however it is preferable to perform the S205 and S207 after S203 is performed in order registered biometric information not to be able to be composed when biometric information for authentication is not yet obtained from a user.

Also, in the methods described above, a level of security may be improved by encrypting all of transmitting data between the biometric authentication apparatus 150 and the database 110 as well as of storing biometric information on the database 110.

As described in FIG. 1, in a case where the 0 separated biometric information that is separated biometric information but not mapped by a identifier is stored on the removable storage unit of a user 130), the authenticating unit 157 in S213 will compose registered biometric information using n number of separated biometric information provided from the databases 110-1, 110-2, 110-n and the 0 separated biometric information together.

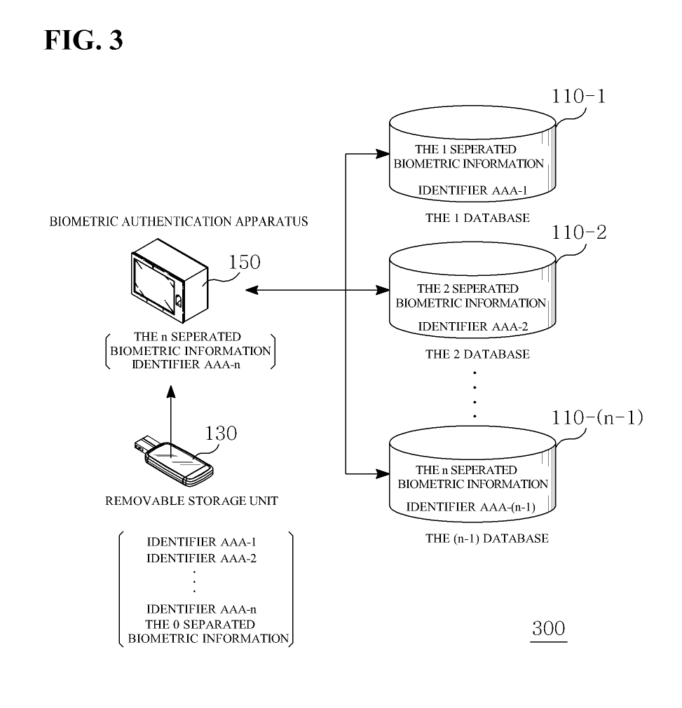

The biometric information authentication system 300 according to another exemplary embodiment illustrated in FIG. 3 is the same system as the biometric information authentication system 100 illustrated in FIG. 1 and operates in the same way as the biometric information authentication system 100 does. However, the biometric authentication apparatus 150 possesses and manages a part of n number of separated biometric information and a plurality of databases may manage the remaining of the n number of separated biometric information.

FIG. 3 is a view illustrating a case where the biometric authentication apparatus 150 possesses the n separated biometric information and the databases 110-1, 110-2, 110-n−1 possess and manage the remaining n−1 number of separated biometric information. In this case, the authenticating unit 157 in S213 will compose registered biometric information by using n−1 number of separated biometric information provided from the databases 110-1, 110-2, 110-n−1 and the n separated biometric information (in the exemplary embodiment in FIG. 3, the 0 separated biometric information) stored on its own together.

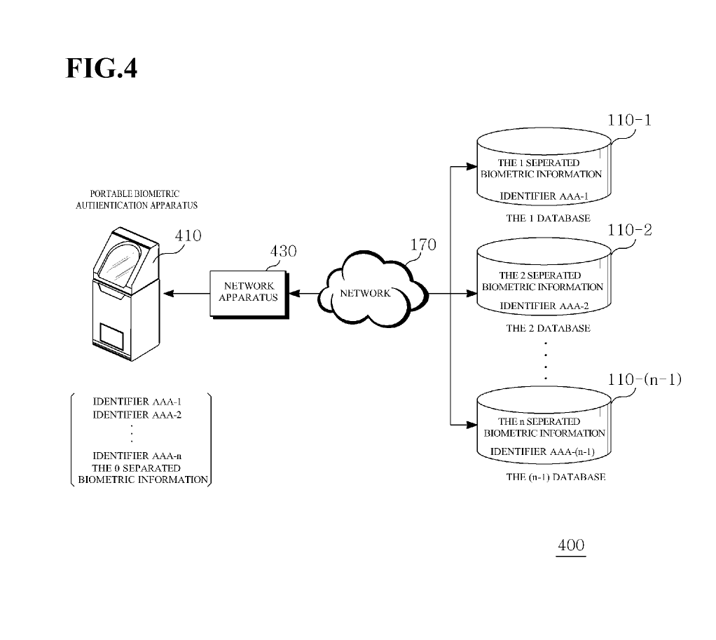

With reference to FIG. 4, another exemplary embodiment of the present invention is provided. A biometric information authentication system 400 illustrated in FIG. 4 may be explained the same as the biometric information authentication system 100 illustrated in FIG. 1, however, it comprises a portable biometric authentication apparatus 410 and a network apparatus 430 which are functional equivalent of the biometric authentication apparatus 150 and the removable storage unit 130, instead of comprising the biometric authentication apparatus 150 and the removable storage unit 130.

The portable biometric authentication apparatus 410 is composed of the biometric information generating unit (151) of the biometric authentication apparatus 150, the storage unit interface 153 of the biometric authentication apparatus 150 and the authenticating unit 157 of the biometric authentication apparatus 150 and the removable storage unit 130 in a single body, and the explanations presented above on the biometric information generating unit 151, the authenticating unit 157 and the removable storage unit 130 apply to this exemplary embodiment.

Accordingly, the biometric information generating unit within the portable biometric authentication apparatus 410 captures biometric information for authentication from a user, and then the authenticating unit of the portable biometric authentication apparatus 410 composes registered biometric information by being provided with separated biometric information from the databases 110-1˜110-n using identifier stored on its own. In a case where any separated biometric information that is not mapped onto by any identifier exists as illustrated, this could be used for composition of registered biometric information.

The portable biometric authentication apparatus 410 is carried about by a user, and may be a bio security token or others having wireless means such as Universal Serial Bus (USB) interface or Bluetooth for transmitting/receiving with the biometric information generating unit.

The network apparatus (430) is connected with the portable biometric authentication apparatus 410 via Universal Serial Bus (USB) interface, etc, and has the portable biometric authentication apparatus 410 connected to the databases 110-1, 110-2, 110-n via the network 170. The network apparatus (430) may be a general computer, a note book, a mobile phone, etc.

According to another exemplary embodiment, the biometric authentication apparatus and the portable biometric authentication apparatus illustrated in FIGS. 1, 3 and 4 may comprise ‘a biometric information composing unit (not shown)’ that composes registered biometric information using separated biometric information. In this case, the authenticating unit will perform a user authentication only by comparing the composed registered biometric information to biometric information for authentication.

A system for biometric information authentication according the present invention significantly reduces the possibility of leakage of whole biometric information of a user by separating biometric information of a user into a plurality of separated biometric information, dispersing them to a plurality of databases and managing them, although a part of separated biometric information may be leaked out due to hacking on databases or other unfortunate accidents.

Accordingly, the present invention addresses the risk of hacking or theft of biometric information which is stored on a server, etc.

Also, although a removable storage unit, etc are lost or stolen, if the lost or stolen thing is just a removable storage, a token or a bio security token, it does not cause any problem since it is possible to get a service only when an authentication is successful.

The foregoing embodiments are merely exemplary and not to be construed as limiting. The present teaching can be readily applied to other types of apparatuses. Also the description of the exemplary embodiments is intended to be illustrative, and not to limit the scope of the claims, and may alternatives, modifications, and variations will be apparent to those skilled in the art.

What is claimed is:

1. A system for biometric authentication, comprising:
a plurality of databases that separately stores each of a plurality of separated biometric information generated by separating the registered biometric information of a user and separately manages each of them;
a removable storage unit that stores a plurality of identifiers corresponding to each of the plurality of the separated biometric information; and
a biometric authentication apparatus that authenticates the user by receiving an input of biometric information for authentication from the user and comparing it to the registered biometric information,
wherein the biometric authentication apparatus comprises a biometric information composing unit that makes a request for the separated biometric information to the plurality of databases using a plurality of identifiers that are read from the removable storage unit and composes the registered biometric information using the plurality of separated biometric information provided by the plurality of databases according to the request, and an authenticating unit that compares the composed registered biometric information to the biometric information for authentication and proceeds with the authentication.

2. The system of claim 1, wherein the registered biometric information is separated into more number of biometric information than the number of the identifier;
a separated biometric information that is not mapped onto by the identifier is stored on removable storage unit; and
the biometric information composing unit composes the registered biometric information using the separated biometric information stored on the removable storage unit and the plurality of separated biometric information provided from the plurality of databases at an authentication stage.

3. The system of claim 1, wherein a part of the separated plurality of separated biometric information is stored on the biometric authentication apparatus instead of the databases.

4. A system for biometric authentication, comprising:
a plurality of databases that separately stores each of a plurality of separated biometric information generated by separating registered biometric information of a user and separately manages each of them;
a portable biometric authentication apparatus that authenticates the user by receiving an input of biometric information for authentication from the user and comparing it to the registered biometric information; and
a network apparatus that connects a network between the biometric authentication apparatus and the plurality of databases,
wherein the biometric authentication apparatus comprises a biometric information composing unit that makes a request for the separated biometric information to the plurality of databases using a plurality of identifiers corresponding to each of the plurality of separated biometric information and composes the registered biometric information using the plurality of the separated biometric information provided by the plurality of databases according to the request, and an authenticating unit that compares the composed registered biometric information to the biometric information for authentication and proceeds with the authentication.

5. The system of claim 4, wherein a part of the separated plurality of separated biometric information is stored on the biometric authentication apparatus instead of the databases.

6. The system of claim 4, wherein the registered biometric information is separated into more number of separated biometric information than the number of the identifier;
a separated biometric information that is not mapped onto by the identifier is stored on the biometric authentication apparatus; and
the biometric information composing unit composes the registered biometric information using the separated biometric information stored on itself and the plurality of separated biometric information provided from the plurality of databases at an authentication stage.

7. A biometric authenticating system, comprising:
an biometric authentication apparatus that authenticates the user by receiving an input of biometric information for authentication from a user and comparing it to registered biometric information, and separately stores each of a plurality of separated biometric information generated by separating the registered biometric information; and
a removable storage unit that stores a plurality of identifier corresponding to each of the plurality of separated biometric information,
wherein the biometric authentication apparatus searches and extracts separated biometric information that is corresponding to a plurality of identifiers that are read from the removable storage unit, out of all the separated biometric information that the apparatus has, and composes the registered biometric information using them, and proceeds with the authentication.

8. A system of claim 7, wherein the registered biometric information is separated into more number of biometric information than the number of the identifier;
a separated biometric information that is not mapped onto by the identifier is stored on the removable storage unit; and
the biometric authentication apparatus composes the registered biometric information using the separated biometric information that are stored on the removable storage unit and the separated biometric information extracted by the identifiers at an authentication stage.

9. A method for authenticating a user, comprising:
storing separately each of a plurality of separated biometric information generated by separating registered biometric information of a user on a plurality of databases and separately managing each of them; and
authenticating the user by receiving an input of biometric information for authentication from the user and comparing it to the registered biometric information, after a biometric authentication apparatus is connected to a removable storage unit that stores a plurality of identifiers corresponding to each of the plurality of separated biometric information,
wherein the authenticating comprises requesting the separated biometric information to the plurality of databases using a plurality of identifiers that are read from the removable storage unit and being provided with them, and composing, by the biometric authentication apparatus, registered biometric information for authentication using the provided plurality of separated biometric information.

10. The method of claim 9, wherein the registered biometric information is separated into more number of biometric information that the number of the identifier;
a separated biometric information that is not mapped onto by the identifier is stored on the removable storage unit; and
the composing composes the registered biometric information using the separated biometric information stored on the removable storage unit and the plurality of separated biometric information provided from the plurality of databases.

11. The method of claim 9, wherein a part of the separated plurality of separated biometric information is stored in the biometric authentication apparatus instead of the databases.

12. A method for authenticating a user, comprising:
storing separately each of a plurality of separated biometric information generated by separating registered biometric information of a user on a plurality of databases and separately managing each of them; and
receiving an input of biometric information for authentication from the user, comparing it to the registered biometric information and authenticating the user, by a portable biometric authentication apparatus that stores a plurality of identifiers corresponding to each of the plurality of separated biometric information,
wherein the authenticating comprises making a request for the separated biometric information to the plurality of databases using the plurality of identifiers and being provided with it by the biometric authentication apparatus, and composing the registered biometric information for authentication using the provided plurality of separated biometric information by the biometric authentication apparatus.

13. The method of claim 12, wherein a part of the separated plurality of separated biometric information is stored on the biometric authentication apparatus instead of the databases.

14. The method of claim 12, wherein the registered biometric information is separated into more number of separated biometric information than the number of the identifier;
a separated biometric information that is not mapped onto by the identifier is stored on the biometric authentication apparatus; and
the composing composes the registered biometric information using separated biometric information stored on itself and the plurality of separated biometric information provided from the plurality of databases.

15. A method for authenticating a user, comprising:
separating registered biometric information of a user into a plurality of separated biometric information and storing it; and
authenticating the user by receiving an input of biometric information for authentication from the user and comparing it to the registered biometric information by the biometric authentication apparatus, after the biometric authentication apparatus is connected to a removable storage unit that stores a plurality of identifiers corresponding to each of the plurality of separated biometric information,
wherein the authenticating comprises searching and extracting separated biometric information corresponding to each of a plurality of identifiers that are read from the removable storage unit, and composing the registered biometric information using them.

16. The method of claim 15, wherein the registered biometric information is separated into more number of separated biometric information than the number of the number of identifier;
a separated biometric information that is not mapped onto by the identifier is stored on the removable storage unit; and
the authenticating comprises composing the registered biometric information using separated biometric information stored on the removable storage unit and the separated biometric information extracted by the identifiers.
